(19) United States
(12) Patent Application Publication
(10) Pub. No.: US 2025/0312758 A1
(43) Pub. Date: Oct. 9, 2025

(54) HYDROGEN GENERATION APPARATUS

(71) Applicant: CANON KABUSHIKI KAISHA, Tokyo (JP)

(72) Inventors: KEIJI KARUBE, Ibaraki (JP); SHOKO FUJIWARA, Ibaraki (JP); TSUYOSHI KUROKI, Kanagawa (JP); SHUNSUKE TSUDA, Tokyo (JP); AKIKO TOMINAGA, Kanagawa (JP); KENJI UTSUNOMIYA, Tokyo (JP)

(21) Appl. No.: 19/241,125

(22) Filed: Jun. 17, 2025

Related U.S. Application Data
(63) Continuation of application No. PCT/JP2023/044540, filed on Dec. 13, 2023.

(30) Foreign Application Priority Data
Dec. 20, 2022 (JP) 2022-203049

(51) Int. Cl. B01J 8/10; C01B 3/06

(52) U.S. Cl. CPC B01J 8/10; C01B 3/065; B01J 2208/00433; B01J 2208/00893; C01B 2203/0855; C01B 2203/1205

(57) ABSTRACT

A hydrogen generation apparatus applies a solid hydrogen carrier on a surface of a conveyance belt by an application apparatus, and ejects, by an ejection apparatus, a liquid containing water onto the hydrogen carrier applied on the surface. A hydrogen collection apparatus collects hydrogen generated by a reaction between the hydrogen carrier and the liquid on the surface. A byproduct generated by the reaction between the hydrogen carrier and the liquid on the surface is collected by a byproduct collection apparatus. A heating apparatus heats the conveyance belt 41.

### CROSS-REFERENCE TO RELATED APPLICATIONS

This application is a Continuation of International Patent Application No. PCT/JP2023/044540, filed Dec. 13, 2023, which claims the benefit of Japanese Patent Application No. 2022-203049, filed Dec. 20, 2022, both of which are hereby incorporated by reference herein in their entirety.

### BACKGROUND

### Field of the Technology

The present disclosure relates to a hydrogen generation apparatus that generates hydrogen by using, as a raw material, a hydrogen carrier having a nature of generating hydrogen when a water-containing liquid is poured thereon.

### Description of the Related Art

As a hydrogen generation apparatus, an apparatus that supplies water and a solvent to sodium borohydride and generates hydrogen by hydrolysis of the sodium borohydride is proposed (for example, Patent Literature 1).

### CITATION LIST

### Patent Literature

Patent Literature 1: Japanese Patent Application Laid-Open No. 2017-114708

### SUMMARY

Here, there is a case where an additive such as a reaction accelerator is used for stable progress of hydrolysis of a hydrogen carrier such as sodium borohydride. In the case of generating hydrogen by hydrolysis of sodium borohydride, a byproduct such as sodium metaborate is generated. The byproduct can be restored into a hydrogen carrier such as sodium borohydride, but in the case where an additive such as a reaction accelerator remains in the byproduct, the restoration of the byproduct into the hydrogen carrier requires more effort. Therefore, a configuration in which the reaction between the hydrogen carrier and the water-containing liquid can be promoted even if the additive is not added or the amount of added additive is reduced is desired.

The present disclosure provides a hydrogen generation apparatus that easily promotes a reaction between a hydrogen carrier and a water-containing liquid.

According to one aspect of the present disclosure, a hydrogen generation apparatus includes a conveyance belt, an application apparatus configured to apply a solid hydrogen carrier on a surface of the conveyance belt, an ejection apparatus configured to eject a liquid containing water onto the hydrogen carrier applied on the surface of the conveyance belt, a hydrogen collection apparatus configured to collect hydrogen generated by a reaction between the hydrogen carrier and the liquid on the surface of the conveyance belt, a byproduct collection apparatus configured to collect a byproduct generated by the reaction between the hydrogen carrier and the liquid on the surface of the conveyance belt, and a heating apparatus configured to heat the conveyance belt.

Features of the present disclosure will become apparent from the following description of embodiments with reference to the attached drawings.

### BRIEF DESCRIPTION OF THE DRAWINGS

FIG. 1 is a schematic configurational section view of a hydrogen generation apparatus according to a first embodiment.

FIG. 2 is a control block diagram of the hydrogen generation apparatus according to the first embodiment.

FIG. 3 is a schematic configurational section view illustrating an enlarged view of a heated part of a conveyance belt in the hydrogen generation apparatus according to the first embodiment.

FIG. 4 is a schematic configurational section view illustrating an enlarged view of a heated part of a conveyance belt in a hydrogen generation apparatus according to a second embodiment.

FIG. 5 is a schematic configurational section view illustrating an enlarged view of a heated part of a conveyance belt in a hydrogen generation apparatus according to a third embodiment.

FIG. 6 is a schematic configurational section view illustrating an enlarged view of a heated part of a conveyance belt in a hydrogen generation apparatus according to a fourth embodiment.

### DESCRIPTION OF THE EMBODIMENTS

### First Embodiment

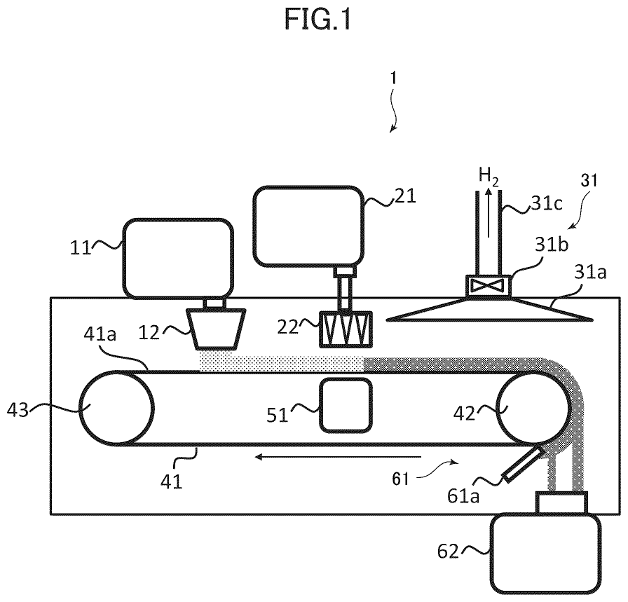

A first embodiment will be described with reference to FIGS. 1 to 3. First, hydrogen is attracting attention as an energy source to replace fossil fuel. This is because, unlike fossil fuel, when being combusted, hydrogen does not generate, for example, carbon dioxide that is a kind of a greenhouse gas that causes global warming. One example of a system that uses hydrogen as an energy source and that is put into practical use is a fuel cell vehicle. A fuel cell vehicle is an automobile that generates power by using hydrogen as a raw material and moves by driving an electric motor by the generated power. Most of fuel cell vehicles store hydrogen serving as an energy source in a hydrogen tank, and generates power by charging the hydrogen discharged from the hydrogen tank into a fuel cell. In the hydrogen tank, hydrogen is stored in a compressed state at a high pressure such as 70 MPa (700 times as high as atmospheric pressure).

Hydrogen serving as an energy source has a problem that the energy density thereof is low. The volume energy density of hydrogen is about 1/3000 of that of gasoline, and energy of only about ⅕ of that of gasoline of the same volume can be obtained even if the hydrogen tank of 70 MPa is used. Therefore, typically, a fuel cell vehicle including a hydrogen tank is required to be charged with energy more frequently than an automobile using gasoline.

Therefore, as a material (that is, a hydrogen carrier) that can carry hydrogen at a higher energy density than a hydrogen tank, various materials are considered. For example, ammonia, methylcyclohexane, and the like are known as hydrogen carriers, and transporting a hydrogen carrier instead of hydrogen itself and taking out hydrogen from the hydrogen carrier at use are performed.

Among hydrogen carrier materials like these, metal hydrides such as sodium borohydride from which hydrogen can be easily taken out by pouring water thereon are widely known. As a method of obtaining hydrogen by hydrolysis of sodium borohydride, a method of dissolving sodium borohydride in water and using it as an aqueous solution is known. However, in the case of this method, there is a problem that more water than an amount required in the theory represented by the reaction formula is required, and thus the substantial volume energy density is reduced.

Therefore, in the present embodiment, hydrogen is generated by pouring a water-containing liquid on a solid hydrogen carrier by a hydrogen generation apparatus configured as described below. In addition, a byproduct generated by the reaction between the hydrogen carrier and the liquid is collected. The byproduct can be restored into the hydrogen carrier. [Hydrogen Generation Apparatus]

A schematic configuration of hydrogen generation apparatus 1 will be described by using FIG. 1. The hydrogen generation apparatus 1 of the present embodiment is an apparatus that places a hydrogen carrier that is solid (powder in the present embodiment) on the conveyance belt 41, ejects a water-containing liquid thereonto, reacts the hydrogen carrier with the water-containing liquid on the conveyance belt 41, and thus generates hydrogen. The hydrogen generation apparatus 1 mainly includes the conveyance belt 41, a powder application apparatus 12 serving as an application apparatus, a liquid ejection apparatus 22 serving as an ejection apparatus, a hydrogen collection apparatus 31, and a byproduct collection apparatus 61.

The conveyance belt 41 rotates in an arrow direction of FIG. 1. The powder application apparatus 12 receives supply of hydrogen carrier from a hydrogen carrier storage case 11 storing a hydrogen carrier that is powder, and applies the hydrogen carrier on a surface 41a of the conveyance belt 41. The liquid ejection apparatus 22 is disposed downstream of the powder application apparatus 12 in the rotational direction of the conveyance belt 41, receives supply of the liquid from a liquid storage case 21 storing the water-containing liquid, and ejects the liquid onto the hydrogen carrier applied on the surface 41a of the conveyance belt 41.

The hydrogen collection apparatus 31 is disposed downstream of the liquid ejection apparatus 22 in the rotational direction of the conveyance belt 41, and collects hydrogen generated by the reaction between the hydrogen carrier and the liquid on the surface 41a of the conveyance belt 41. The byproduct collection apparatus 61 collects the byproduct generated by the reaction between the hydrogen carrier and the liquid on the surface 41a of the conveyance belt 41. The byproduct mentioned herein refers to a product other than hydrogen generated by the reaction between the hydrogen carrier and the liquid. In addition, the hydrogen generation apparatus 1 of the present embodiment further includes a heating apparatus 51 that heats the conveyance belt 41.

The hydrogen generation apparatus 1 can perform, on the conveyance belt 41, a series of steps such as generating hydrogen by the reaction between the hydrogen carrier and the water-containing liquid, and collecting the byproduct after the reaction. Therefore, an advantage that hydrogen can be generated continuously, stably, and in a long term is realized in a compact apparatus configuration.

The operation of the hydrogen generation apparatus 1 is as follows. First, the conveyance belt 41 starts moving, and the heating apparatus 51 starts heating at the same timing. When the conveyance speed of the conveyance belt 41 has become stable at a predetermined speed and the surface temperature of the conveyance belt 41 has reached a set temperature, the powder application apparatus 12 starts operating, and applies the hydrogen carrier on the conveyance belt 41. At a timing at which the hydrogen carrier comes under the liquid ejection apparatus 22, the liquid is ejected from the liquid ejection apparatus 22, the reaction between the hydrogen carrier and the liquid is started, and the generated hydrogen is collected by the hydrogen collection apparatus 31.

Then, the byproduct generated after the reaction between the hydrogen carrier and the water-containing liquid is conveyed to the byproduct collection apparatus 61, and the byproduct is collected and sent to a byproduct collection case 62 by the byproduct collection apparatus 61. Next, each constituent element will be described in detail.

### [Hydrogen Carrier]

The “hydrogen carrier” mentioned in the present embodiment is not particularly limited as long as the hydrogen carrier is a solid hydrogen carrier that generates hydrogen when a water-containing liquid is poured thereon. For example, solid metal hydrides such as sodium borohydride, potassium borohydride, lithium borohydride, zinc borohydride, aluminum lithium hydride, aluminum sodium hydride, aluminum magnesium hydride, aluminum calcium hydride, magnesium hydride, lithium hydride, sodium hydride, and calcium hydride, and metal powder such as aluminum, zinc, calcium, and magnesium can be used solely or in combination. In addition, an additive such as a reaction accelerator or a desiccant may be contained.

In addition, although the hydrogen carrier of the present embodiment is preferably a solid such as powder or granule, but solids such as sheets, pellets, and pastes are also usable. As the powder, one having a particle diameter of about 10 μm or more and 10 mm or less, and one having a particle diameter of 10 μm or more and 3 mm or less, and further one having a particle diameter of 10 μm or more and 100 μm or less are more preferable. In addition, in the case of use in the form of a sheet or a pellet, it is preferable to perform surface roughening, pore-forming treatment, or the like to increase the surface area and increase the contact area with the water-containing liquid from the viewpoint of enhancing the reactivity with the water-containing liquid.

In the present embodiment, a powder of sodium borohydride having an average particle diameter of 50 μm is used as the solid hydrogen carrier. To be noted, the average particle diameter of the solid hydrogen carrier is not limited to this. The sodium borohydride powder reacts with water to generate hydrogen. The reacted sodium borohydride turns into a powder of sodium metaborate that is a byproduct. This reaction is expressed as follows by a chemical formula.

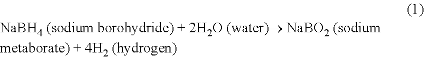

This reaction (chemical formula (1)) is known to be promoted by a Raney catalyst formed from metal such as nickel, cobalt, or copper, and an acidic solution such as citric acid or acetic acid.

### [Water-containing Liquid]

The “water-containing liquid” mentioned in the present embodiment is not particularly limited as long as the liquid reacts with the hydrogen carrier and generates hydrogen when poured. That is, the water-containing liquid may be a simple of water. In addition, two or more kinds of water-containing liquids may be prepared. By preparing two or more kinds of water-containing liquids, the generation speed of hydrogen can be adjusted.

The water-containing liquid can include a water-soluble organic solvent. Examples thereof can include alcohols, polyalkylene glycols, glycol ethers, nitrogen-containing compounds, and sulfur-containing compounds. Two kinds or more selected from these can be also used in mixture. By containing a water-soluble organic solvent, adjustment of the surface tension, adjustment of the boiling point and melting point of the water-containing liquid can be performed to optimize the reaction with the hydrogen carrier.

A surfactant can be added to the water-containing liquid. By using the surfactant, the surface tension of the water-containing liquid can be reduced, the contact area with the hydrogen carrier can be increased, and thus efficient reaction can be performed.

The water-containing liquid can contain a water-soluble acidic substance. The acidic substance functions as a positive catalyst in the reaction between the water-containing liquid and the hydrogen carrier. By adjusting the amount of the liquid containing the acidic substance, the generation speed of hydrogen can be adjusted. Particularly, by setting the pH obtained by the water-containing liquid and the hydrogen carrier to be lower than 9.0, the hydrogen generation speed can be increased. Examples thereof include various acids such as chloric acid, sulfuric acid, nitric acid, boric acid, and organic acids, but are not limited to these.

The water-containing liquid can include a water-soluble basic substance. The basic substance functions as a negative catalyst in the reaction between the water-containing liquid and the hydrogen carrier. By adjusting the amount of the liquid containing the basic substance, the generation speed of hydrogen can be adjusted. Particularly, by setting the pH obtained by the water-containing liquid and the hydrogen carrier to be equal to or higher than 9.0, the hydrogen generation speed can be reduced. Examples thereof include bases such as sodium hydrate, potassium hydrate, and ammonia water, but are not limited to these.

The water-containing liquid can include a buffer liquid. The buffer liquid functions to suppress pH fluctuation in the reaction between the water-containing liquid and the hydrogen carrier. By adjusting the amount of the liquid containing the buffer liquid, the generation speed of hydrogen can be adjusted. Examples thereof include various buffer liquids such as a phosphoric acid buffer liquid, a glycine buffer liquid, a Good's buffer liquid, a Tris buffer liquid, and an ammonia buffer liquid, but are not limited to these.

The water-containing liquid may contain various additives such as a defoaming agent, a pH adjuster, a viscosity adjuster, a rust inhibitor, an antiseptic agent, an antifungal agent, an antioxidant, and an anti-reduction agent in addition to the components described above if necessary.

### [Conveyance Belt]

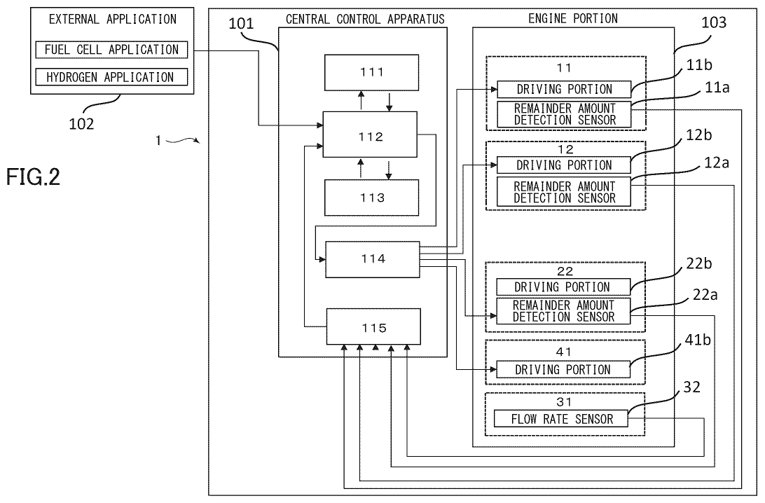

The conveyance belt 41 serving as a conveyance member is an endless belt, and is capable of conveying the solid hydrogen carrier. The conveyance belt 41 is stretched by the driving roller 42 and the driven roller 43. The driving roller 42 is fixed, the driven roller 43 is subjected to a force pushing out the driven roller 43 to the front surface side of the conveyance belt by the urging force of an unillustrated urging spring, and a certain tension is applied to the conveyance belt 41 due to this force. In addition, the driving roller 42 is coupled to a driving portion 41b (see FIG. 2) such as a motor, and thus the conveyance belt 41 circulates (i.e. rotates) in a clockwise direction (arrow direction) of FIG. 1 as a result of the driving roller 42 being rotationally driven by the driving portion 41b. Although the conveyance belt 41 is supported by two rollers in the present embodiment, there is no problem if, for example, the conveyance belt 41 is supported by a plurality of rollers such as three rollers.

In either case, the conveyance belt 41 is provided such that a stretched surface stretched by two rollers (the driving roller 42 and the driven roller 43 in the present embodiment), that is, the surface 41a described above is oriented in approximately the horizontal direction. In addition, the surface 41a is a surface facing up, and the powder application apparatus 12, the liquid ejection apparatus 22, and the hydrogen collection apparatus 31 disposed above the conveyance belt 41 oppose the surface 41a.

The conveyance belt 41 configured in this manner includes a mechanism that functions to convey the hydrogen carrier applied on the conveyance belt 41 by the powder application apparatus 12 toward the downstream side in the rotational direction in the order of the liquid ejection apparatus 22 and the hydrogen collection apparatus 31. After this, the byproduct after the reaction is conveyed further downstream to the byproduct collection apparatus 61. In addition, the heating apparatus 51 that heats the conveyance belt 41 from the inner peripheral surface side is provided on the inner side of the conveyance belt 41.

The conveyance belt 41 is preferably imparted with electrical conductivity from the viewpoint of not causing static electricity, and may be formed from metal or resin. In the case of metal, aluminum, iron, copper, Ni, stainless steel (SUS), and the like can be used. In addition, in the case of resin, a resin having a high glass transition temperature is preferable from the viewpoint of heat resistance, and for example, engineering plastics having high heat resistance and high durability such as polyimide, polyamideimide, and polyether ether ketone are preferable. In addition, in the case of resin not having electrical conductivity, it is preferable that the resin contains an antistatic agent such as carbon black to have electrical conductivity imparted. In addition, it is preferable that the thickness of the conveyance belt 41 is about 30 μm or more and 200 μm or less from the viewpoint of thermal conductivity. In the present embodiment, an endless belt formed from resin imparted with electrical conductivity that is polyimide containing carbon is used as the conveyance belt 41.

The conveyance speed (rotational speed) of the conveyance belt 41 is a predetermined speed set for each kind of the hydrogen carrier and the water-containing liquid that are used. In addition, it is preferable that the conveyance speed is adjustable as appropriate in accordance with the required hydrogen amount. As a result of this, in the case where, for example, the amount of hydrogen collected by the hydrogen collection apparatus 31 has not reached a planned amount, the hydrogen generation amount can be adjusted by, for example, appropriately adjusting the conveyance speed in accordance with the hydrogen amount measured by a flow rate sensor 32 (see FIG. 2) or the like that measures the flow rate of the hydrogen collected by the hydrogen collection apparatus 31.

### [Powder Application Apparatus]

The powder application apparatus 12 is an apparatus that receives supply of the hydrogen carrier from the hydrogen carrier storage case 11 and applies the hydrogen carrier on the conveyance belt 41. There is no problem if the thickness of the hydrogen carrier applied on the conveyance belt 41 is about 50 μm or more and 3 mm or less, but it is preferable that the thickness is set to 50 μm or more and 500 μm or less to improve the reactivity with the water-containing liquid.

In addition, the hydrogen carrier storage case 11 serving as a hydrogen carrier replenishment container stores hydrogen carrier (hydrogen carrier for replenishment) for replenishment of the storage portion of the powder application apparatus 12. The hydrogen carrier storage case 11 is attachable to and detachable from the powder application apparatus 12. That is, the hydrogen carrier storage case 11 is replaceable.

### [Liquid Ejection Apparatus]

The liquid ejection apparatus 22 is a liquid application apparatus that receives supply of the water-containing liquid from the liquid storage case 21 storing the water-containing liquid and applies the water-containing liquid on the hydrogen carrier on the conveyance belt 41. The liquid ejection apparatus 22 can adjust the amount of the water-containing liquid with respect to the amount of the hydrogen carrier. The liquid ejection apparatus 22 may eject the liquid onto the conveyance belt 41 in a contactless manner, or may eject the liquid in contact.

The liquid ejection apparatus 22 of a contactless type has no particular problem as long as the liquid ejection apparatus 22 is one that can apply the water-containing liquid on the hydrogen carrier such as a spray system, a shower system, or a dispenser system. Any of these systems can adjust the ejection amount of the liquid. In addition, as the liquid ejection apparatus 22 of a contact type, a gravure offset roller, a bar coater, a die coater, a blade coater, a knife coater, and the like can be mentioned. Any of these systems can adjust the ejection amount of the liquid.

In addition, the liquid storage case 21 serving as a liquid replenishment container stores the water-containing liquid to be supplied to the liquid ejection apparatus 22. The liquid storage case 21 is attachable to and detachable from the liquid ejection apparatus 22. That is, the liquid storage case 21 is replaceable.

### [Hydrogen Collection Apparatus]

The hydrogen collection apparatus 31 is provided for collecting the hydrogen generated by the reaction between the hydrogen carrier and the water-containing liquid. As illustrated in FIG. 1, it may be a canopy structure in a sense of an exhaustion apparatus, or may be one in which an upper outer wall of the hydrogen generation apparatus 1 has a slope shape and a discharge port is provided at the highest position. There is no particular problem as long as the structure collects the hydrogen generated inside the hydrogen generation apparatus 1. The hydrogen collection apparatus 31 of the present embodiment is disposed above the conveyance belt 41, and includes a collection portion 31a that collects the hydrogen generated on the conveyance belt 41, and a suction fan 31b that sucks the hydrogen collected by the collection portion 31a. The hydrogen sucked by the suction fan 31b is supplied to a supply destination such as a fuel cell through a pipe 31c.

In the fuel cell serving as one of supply destinations of hydrogen, dry hydrogen is desired. However, not only hydrogen but also a water vapor or a vapor of an alkaline substance generated by the reaction can mix into the collected gas. Therefore, it is preferable that a mechanism that removes substances other than a hydrogen gas, such as a filter containing water, a filter containing silica gel, or a steam trap incorporating a cooling apparatus, is provided in the flow path for hydrogen such as the pipe 31c.

### [Byproduct Collection Apparatus]

The byproduct collection apparatus 61 functions to remove the byproduct on the conveyance belt 41 from the conveyance belt 41 and send the byproduct to the byproduct collection case 62. The byproduct is, for example, sodium metaborate in the case where the hydrogen carrier is sodium borohydride. The byproduct collection apparatus 61 includes a collection blade 61a that comes into contact with the conveyance belt 41, and a blade holding member (illustration omitted) that holds the collection blade 61a.

The collection blade 61a preferably abuts the outer peripheral surface of the conveyance belt 41 stretched by a roller stretching the conveyance belt 41, which is the driving roller 42 in the present embodiment. In addition, the collection blade 61a preferably abuts a surface other than the surface 41a, such as the lower surface in the vertical direction or a side surface in the horizontal direction of the conveyance belt 41. In addition, the byproduct collection case 62 is preferably disposed below the collection blade 61a in the vertical direction. As a result of this, the byproduct collected by the collection blade 61a can be dropped by the gravity and collected by the byproduct collection case 62.

The material of the collection blade 61a is not particularly limited, and examples thereof include a rubber blade formed from rubber and used for cleaning of an intermediate transfer belt in a copier or the like. This is formed from rubber such as silicone rubber or urethane rubber, is molded into a plate shape, is attached such that the corner portion thereof is in contact in a counter direction with respect to the movement direction of the conveyance belt 41, and thus removes the byproduct on the conveyance belt 41. In addition, there is no problem in using one formed from metal or glass in a spatula shape, which is a so-called scraper, as the collection blade 61a.

The blade holding member has a function to support the collection blade 61a and apply a certain pressure to the collection blade 61a by using the warpage of the blade holding member. Although the material thereof is not particularly limited, metal is preferred because pressure is to be applied.

In addition, the byproduct collection case 62 serving as a collection container is a case for collecting the byproduct collected from the conveyance belt 41 by the collection blade 61a. The byproduct collection case 62 is attachable to and detachable from the byproduct collection apparatus 61. That is, the byproduct collection case 62 is replaceable. [Heating Apparatus]

The heating apparatus 51 has a function to heat the conveyance belt 41 from the inner peripheral surface side to promote the reaction between the hydrogen carrier and the water-containing liquid and stably generate hydrogen. As a result of this, in the hydrolysis reaction of the hydrogen carrier, hydrogen can be stably taken out without using a reaction accelerator such as a catalyst.

In addition, a system of heating the conveyance belt 41 by the heating apparatus 51 is a system having a high energy efficiency in terms of heating as compared with a system such as one heating the hydrogen carrier or one heating the water-containing liquid because the range to be heated can be limited, and the timing of the heating can be performed only during the reaction between the hydrogen carrier and the water-containing liquid.

The heating apparatus 51 may be one that heats the conveyance belt 41 via a film or a belt, one that directly transmits the heat of the heater to the conveyance belt 41, or one that includes a heater of an induction heating system if the conveyance belt 41 is formed from metal. There is no particular limitation as long as heat is quickly transmitted to the conveyance belt 41 and the conveyance belt 41 can be heated quickly. In addition, a configuration in which a heater is provided on the outer peripheral surface side of the conveyance belt 41 and the hydrogen carrier and the water-containing liquid are directly heated has no problem either. To be noted, in the case of a configuration of heating from the outer peripheral surface side, a configuration in which heating is performed via a heating film or the like is preferable because the hydrogen in contact with the heater should be avoided from the viewpoint of safety. The detailed configuration of the heating apparatus 51 will be described later.

### [Central Control Apparatus]

FIG. 2 is a block diagram illustrating a system of the hydrogen generation apparatus 1 of the present embodiment. A central control apparatus 101 includes a controller 112, a random access memory (RAM) 111, a storage 113 that stores a program, a communication interface, a signal transmitting portion 114, and a signal receiving portion 115. The controller 112 is constituted by a central processing unit (CPU) or a CPU and a read-only memory (ROM), and issues a control command to the whole hydrogen generation apparatus 1 by executing the program stored in the storage 113.

The RAM 111 is a main memory for work by the controller 112. The storage 113 is a storage region for storing a control program and the like, and the controller 112 performs processing by reading a control program, time-series data that is temporarily stored, log information, and the like from the RAM 111 and the storage 113.

Information from an external application 102 such as hydrogen application of the fuel cell to which the hydrogen generation apparatus 1 supplies or fuel cell application of a fuel cell vehicle (FCV) or the like that uses a fuel cell is input to the controller 112. In addition, the controller 112 receives information of an engine portion 103 of the hydrogen generation apparatus 1 through the signal receiving portion 115. As the information of the engine portion 103, a hydrogen amount detected by the flow rate sensor 32 provided in the hydrogen collection apparatus 31, information of remainder amount detection sensors 11a, 12a, and 22a provided in the hydrogen carrier storage case 11, the powder application apparatus 12, and the liquid ejection apparatus 22, and the like can be mentioned.

The remainder amount detection sensor 11a is a sensor that is provided in the hydrogen carrier storage case 11 and detects the remainder amount of the hydrogen carrier in the hydrogen carrier storage case 11. The remainder amount detection sensor 12a is a sensor that is provided in the powder application apparatus 12 and detects the remainder amount of the hydrogen carrier in the powder application apparatus 12. The remainder amount detection sensor 22a is a sensor that is provided in the liquid ejection apparatus 22, and detects the remainder amount of the water-containing liquid in the liquid ejection apparatus 22.

Further, the controller 112 transmits, as a signal generated in accordance with a control information set in advance, a replenishment signal to the hydrogen carrier storage case 11, a driving signal to the powder application apparatus 12 and the liquid ejection apparatus 22, a driving signal to the conveyance belt 41, and the like, via the signal transmitting portion 114.

The hydrogen carrier storage case 11 includes a driving portion 11b for replenishing the powder application apparatus 12 with the hydrogen carrier. The powder application apparatus 12 includes a driving portion 12b for applying the hydrogen carrier on the conveyance belt 41. The liquid ejection apparatus 22 includes a driving portion 22b for ejecting the liquid onto the hydrogen carrier on the conveyance belt 41. In addition, the conveyance belt 41 is driven by the driving portion 41b as described above. The controller 112 controls the drive of the driving portions 11b, 12b, 22b, and 41b.

Specifically, the driving portion 11b of the hydrogen carrier storage case 11 is, for example, a motor or a solenoid that drives a shutter provided at a connecting portion between the hydrogen carrier storage case 11 and the powder application apparatus 12. The controller 112 performs and stops the replenishment operation of the hydrogen carrier from the hydrogen carrier storage case 11 to the powder application apparatus 12 by, for example, driving the driving portion 11b to open and close the shutter.

The driving portion 12b of the powder application apparatus 12 is, for example, a motor that drives a roller for applying the hydrogen carrier on the conveyance belt 41. The controller 112 drives the driving portion 12b to control the drive of the roller, and thus performs and stops the application operation of the hydrogen carrier from the powder application apparatus 12 to the surface 41a of the conveyance belt 41.

The driving portion 22b of the liquid ejection apparatus 22 is, for example, provided to eject the liquid onto the conveyance belt 41, and the driving configuration thereof differs depending on the system thereof. The controller 112 controls the drive of the driving portion 22b, and thus performs and stops the liquid ejection operation from the liquid ejection apparatus 22 to the surface 41a of the conveyance belt 41.

The driving portion 41b of the conveyance belt 41 is, for example, a motor as described above. The controller 112 controls the drive of the driving portion 41b, and thus drives and stops the conveyance belt 41, and further controls the driving speed thereof.

### [Detailed Configuration of Heating Apparatus]

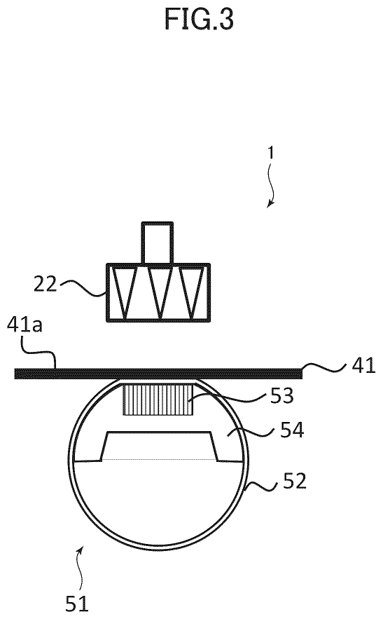

Next, the detailed configuration of the heating apparatus 51 of the present embodiment will be described by using FIG. 3. As described above, the heating apparatus 51 is disposed on the inner side of the conveyance belt 41, and heats the conveyance belt 41 from the inner side. The heating apparatus 51 configured in this manner includes a heating film 52, a heater 53, and a heater holding member 54. The heating film 52 is a tubular belt member abutting the conveyance belt 41, and is a film-shaped member in the present embodiment. The heating film 52 rotates by being driven by the conveyance belt 41. The heater 53 is a heating member that heats the heating film 52, and heats the conveyance belt 41 via the heating film 52. The heater 53 is provided in an inner space of the heating film 52, and comes into contact with the inner peripheral surface of the heating film 52. The heater holding member 54 serving as a holding member holds the heater 53, and also has a guide function of guiding the rotation of the heating film 52.

The heating film 52 preferably has a low heat capacity and a high thermal conductivity from the viewpoint of heating the conveyance belt 41 instantly. The material is not particularly limited, and may be metal or resin. In the case of metal, a thin film formed from aluminum, iron, copper, Ni, or an alloy of these such as stainless steel (SUS) is preferable. In addition, in the case of resin, engineering plastics and the like having high heat resistance and high durability such as polyimide, polyamideimide, and polyether ether ketone are preferable. In addition, a rubber layer may be provided on the heating film 52 to increase the thermal conductivity. In addition, a release layer formed from fluorine resin such as a perfluoroalkoxyalkane (PFA) tube may be provided on the outer peripheral surface of the heating film 52 to increase the slidability with the conveyance belt 41.

Although the heater 53 is not particularly limited either, it is preferable that a ceramic heater, a halogen heater, or the like is used in consideration of the startup performance. Regarding the heater capacity, the size of the conveyance belt 41, the conveyance speed, the thickness of the conveyance belt 41, and the like are designed by calculating the total heat capacity.

To be noted, to raise the temperature of the conveyance belt 41 more quickly, an opposing roller may be provided on the side opposing the heating apparatus 51 with the conveyance belt 41 therebetween, and a heating nip portion where the conveyance belt 41 is nipped by the heating film 52 and the opposing roller may be provided. The position of the heating nip portion is preferably set to a position that is downstream of the liquid ejection apparatus 22, a position where the liquid ejected from the liquid ejection apparatus 22 does not end up on the opposing roller, and a position upstream of the hydrogen collection range of the hydrogen collection apparatus 31 in the rotational direction of the conveyance belt 41. Alternatively, the position of the heating nip portion may be set to a position in the hydrogen collection range upstream of the center of this range.

In addition, a separation mechanism capable of causing the heating apparatus 51 to abut and separate from the conveyance belt 41 may be provided. Further, a configuration in which the heating apparatus 51 is separated from the conveyance belt 41, the heating film 52 is heated in advance, and the heating film 52 is brought into contact with the conveyance belt 41 at the time of heating may be employed.

The heating apparatus 51 is disposed to at least heat a region where the reaction between the hydrogen carrier and the liquid is started. In the present embodiment, a region (heating region) where the conveyance belt 41 is heated by the heating apparatus 51 is configured to include at least a region where the liquid is ejected onto the surface 41a of the conveyance belt 41 from the liquid ejection apparatus 22. Particularly, in the present embodiment, the heating apparatus 51 is disposed at a position right under the liquid ejection apparatus 22 as illustrated in FIG. 3 from the viewpoint of better efficiency of the energy consumption related to heating. In other words, as viewed in the vertical direction while the conveyance belt 41 is omitted, the heating apparatus 51 is configured to overlap with the liquid ejection apparatus 22.

Regarding the heating temperature of the conveyance belt 41, the surface temperature on the outer peripheral surface side of the conveyance belt 41 of the heating region of the heating apparatus 51 is preferably a temperature of 50° C. or higher and lower than 100° C. For example, a temperature detection sensor that detects the temperature of the inner peripheral surface or the outer peripheral surface of the conveyance belt 41 is provided, and the controller 112 (see FIG. 2) controls the heater 53 on the basis of the detection signal of the temperature detection sensor such that the temperature of the surface 41a of the conveyance belt 41 heated by the heating apparatus 51 is a set temperature set within the range of 50° C. or higher and lower than 100° C.

In the case where the surface temperature is lower than 50° C., there is a possibility that the reaction between the hydrogen carrier and the reaction liquid containing water does not progress and thus a sufficient hydrogen generation amount cannot be obtained. In addition, in the case of a temperature higher than 100° C., a problem that at the time of the reaction between the hydrogen carrier and the water-containing liquid, evaporation of the water itself also occurs, and a large amount of water vapor is mixed in the hydrogen collection apparatus 31 becomes more likely to occur. The set temperature is appropriately set in accordance with the kind of the hydrogen carrier, the kind of the liquid, and the like within the temperature range of 50° C. or higher and lower than 100° C. In addition, the set temperature may be changed in accordance with the amount of hydrogen desired to be collected, and the like.

In the present embodiment, an apparatus of an ODF type that is generally used in a fixing apparatus of a copier is employed as the heating apparatus 51. The apparatus of an ODF type includes the heating film 52, the heater 53, and the heater holding member 54 as described above. In the present embodiment, a film having a three-layer structure in which an elastic layer is formed on the outer peripheral surface of a polyimide base layer and a release layer is formed on the outer peripheral surface of the elastic layer is used as the heating film 52. A rod-shaped ceramic heater is used as the heater 53.

The heater 53 is provided to nip the heating film 52 with the conveyance belt 41 by being held by the heater holding member 54. In other words, the heater 53 opposes the inner peripheral surface of the conveyance belt 41 with the heating film 52 therebetween. To be noted, another member such as a heat transmitting member may be provided between the heating film 52 and the heater 53.

In the case of the present embodiment configured in this manner, the conveyance belt 41 is heated by the heating apparatus 51, and therefore the reaction between the hydrogen carrier and the water-containing liquid can be easily promoted on the conveyance belt 41. Particularly, in the present embodiment, the region (heating region) where the conveyance belt 41 is heated by the heating apparatus 51 is set to at least include a region where the liquid is ejected from the liquid ejection apparatus 22 onto the surface 41a of the conveyance belt 41. Therefore, in a state in which the liquid has been poured on the hydrogen carrier, these are heated, and thus the reaction between the hydrogen carrier and the liquid can be efficiently promoted.

Therefore, according to the hydrogen generation apparatus 1 of the present embodiment, the reaction between the hydrogen carrier and the water-containing liquid can be promoted even without adding an additive such as a reaction accelerator, or even when the amount of the added additive is reduced. As a result of this, the effort taken to restore the byproduct into the hydrogen carrier can be reduced.

### Second Embodiment

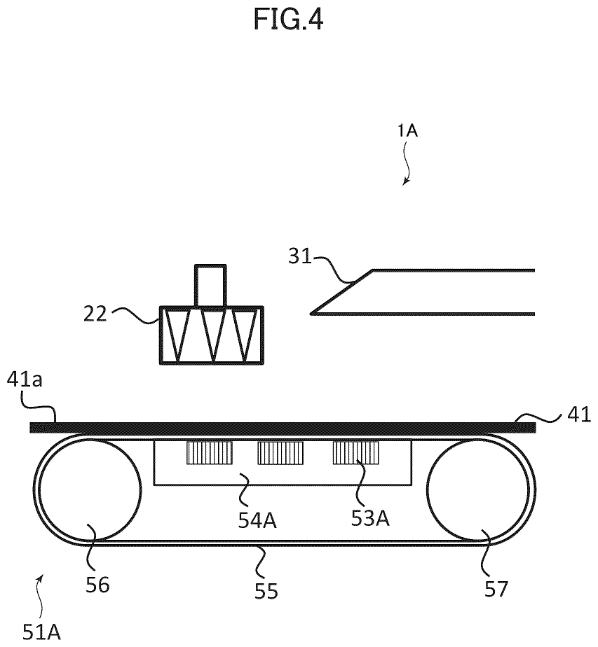

A second embodiment will be described by using FIG. 4. A hydrogen generation apparatus 1A of the present embodiment is different from the first embodiment in the configuration of the heating apparatus that heats the conveyance belt 41. The other configurations and functions are similar to those of the first embodiment described above, therefore similar elements are denoted by the same reference signs, description and illustration thereof will be omitted or simplified, and part different from the first embodiment will be mainly described.

A heating apparatus 51A of the present embodiment includes a driving roller 56 and a driven roller 57 serving as at least one pair of stretch rollers stretching a belt member 55, and is configured to cause a region of the belt member 55 stretched by the driving roller 56 and the driven roller 57 to abut the conveyance belt 41. That is, the heating apparatus 51A includes the belt member 55 having an endless shape, the driving roller 56, the driven roller 57, a heater 53A serving as a heating member, and a heater holding member 54A. The heater 53A is disposed between the driving roller 56 and the driven roller 57, and is held by the heater holding member 54A.

In addition, in the present embodiment, a plurality of (three in the present embodiment) heaters 53A are arranged at constant intervals in the rotational direction of the conveyance belt 41, and are held by the heater holding member 54A. Also in the case of the present embodiment, each heater 53A is a rod-like ceramic heater. In addition, in the present embodiment, the driving roller 56 is rotationally driven by an unillustrated motor, and thus the belt member 55 is rotated in synchronization with the rotation of the conveyance belt 41.

In the case of the present embodiment configured in this manner, the belt member 55 is stretched by the driving roller 56 and the driven roller 57, and thus the contact range of the belt member 55 with the conveyance belt 41 is configured wider than in the configuration of the first embodiment. Specifically, the region where the conveyance belt 41 is heated by the heating apparatus 51A is configured to include a region where the liquid is ejected from the liquid ejection apparatus 22 onto the surface 41a of the conveyance belt 41 and a portion right under a part of the hydrogen collection apparatus 31. That is, as a result of the plurality of heaters 53A including a part right under the liquid ejection apparatus 22 and being disposed in a range to a position right under an upstream part of the hydrogen collection apparatus 31 in the rotational direction of the conveyance belt 41, the conveyance belt 41 can be heated in a wide range.

By setting the heating region wide as described above, an unreacted component of the hydrogen carrier can be eliminated or reduced, and moisture remaining after the reaction can be made more likely to evaporate. As a result of this, the hydrogen can be generated more efficiently, and the unreacted hydrogen carrier can be reduced to use the hydrogen carrier more effectively.

### Third Embodiment

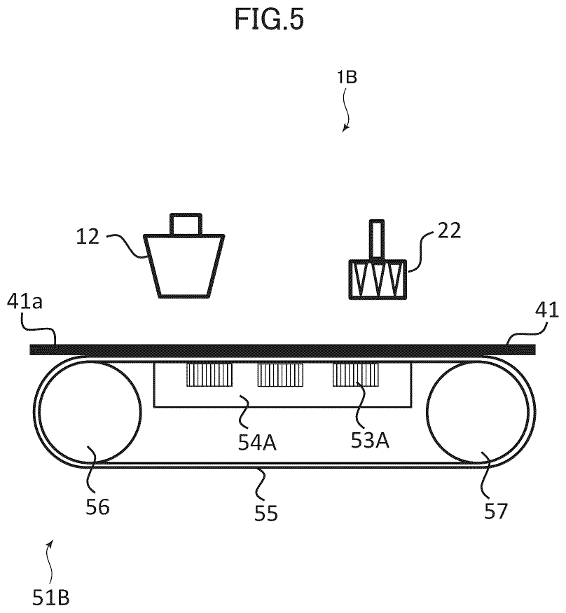

A third embodiment will be described by using FIG. 5. A hydrogen generation apparatus 1B of the present embodiment is different from the second embodiment in the position of the heating apparatus that heats the conveyance belt 41. The other configurations and functions are similar to those of the second embodiment described above, therefore similar elements are denoted by the same reference signs, description and illustration thereof will be omitted or simplified, and part different from the second embodiment will be mainly described.

The configuration itself of a heating apparatus 51B of the present embodiment is similar to that of the heating apparatus 51A of the second embodiment. To be noted, in the present embodiment, the region where the conveyance belt 41 is heated by the heating apparatus 51B is configured to include a region where the hydrogen carrier from the powder application apparatus 12 is applied on the surface 41a of the conveyance belt 41. That is, the plurality of heaters 53A are arranged throughout a range from a position right under the powder application apparatus 12 to a position right under the liquid ejection apparatus 22 in the rotational direction of the conveyance belt 41. In other words, the position where the conveyance belt 41 is heated by the heating apparatus 51B starts from a position right under the powder application apparatus 12. To be noted, the region where the conveyance belt 41 is heated by the heating apparatus 51B may be set to a range extending to a position right under an upstream part of the hydrogen collection apparatus 31 in the rotational direction of the conveyance belt 41.

As described above, in the present embodiment, the region where the conveyance belt 41 is heated by the heating apparatus 51B starts from a position upstream of a position right under the liquid ejection apparatus 22 in the rotational direction of the conveyance belt 41. Therefore, the hydrogen carrier can be heated before the liquid is ejected onto the hydrogen carrier, and the start of the reaction between the hydrogen carrier and the liquid can be improved. As a result of this, the hydrogen generation amount in the beginning of the reaction can be increased, and hydrogen can be generated efficiently.

### Fourth Embodiment

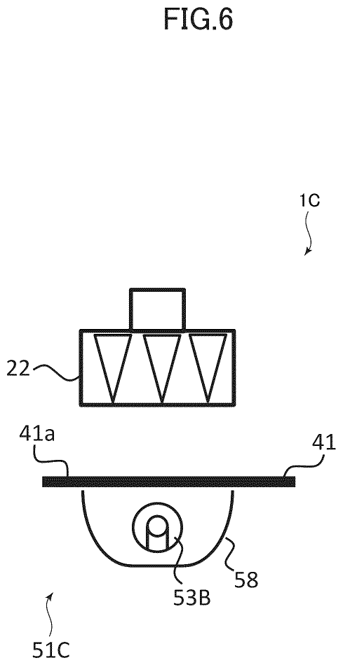

A fourth embodiment will be described by using FIG. 6. A hydrogen generation apparatus 1C of the present embodiment is different from the first embodiment in the configuration of the heating apparatus that heats the conveyance belt 41. The other configurations and functions are similar to those of the first embodiment described above, therefore similar elements are denoted by the same reference signs, description and illustration thereof will be omitted or simplified, and part different from the first embodiment will be mainly described.

The heating apparatus 51C of the present embodiment includes a heater 53B serving as a heating member that directly heats the conveyance belt 41. That is, unlike each embodiment described above, the heating apparatus 51C employs a system in which the conveyance belt 41 is heated by the heater 53B not via a belt member but directly. In addition, the heating apparatus 51C includes, on the side of the heater 53B opposite to the side where the conveyance belt 41 is provided, a reflection plate 58 equipped with a heat insulating material, in addition to the heater 53B. The reflection plate 58 has a shape to surround the heater 53B except for the conveyance belt 41 side thereof, and is configured to reflect the heat of the heater 53B disposed on the inner side thereof toward the conveyance belt 41.

In the present embodiment, a halogen heater is used as the heater 53B. In addition, as the reflection plate 58, a metal plate formed from an aluminum alloy whose outside is covered by a heat insulation material is used. The reflective surface on the inside of the reflection plate 58 is mirror-finished such that radiant heat from the heater 53B can be efficiently transmitted to the conveyance belt 41.

Also in the case of the present embodiment configured in this manner, the heating apparatus 51C is disposed right under the liquid ejection apparatus 22. To be noted, a plurality of heaters 53B may be provided, and the reflection plate 58 may be disposed to cover the plurality of heaters such that a wide range of the conveyance belt 41 is heated as in the second and third embodiments.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A hydrogen generation apparatus comprising:
a conveyance belt;
an application apparatus configured to apply a solid hydrogen carrier on a surface of the conveyance belt;
an ejection apparatus configured to eject a liquid containing water onto the hydrogen carrier applied on the surface of the conveyance belt;
a hydrogen collection apparatus configured to collect hydrogen generated by a reaction between the hydrogen carrier and the liquid on the surface of the conveyance belt;
a byproduct collection apparatus configured to collect a byproduct generated by the reaction between the hydrogen carrier and the liquid on the surface of the conveyance belt; and
a heating apparatus configured to heat the conveyance belt.

2. The hydrogen generation apparatus according to claim 1, wherein a temperature of the surface of the conveyance belt heated by the heating apparatus is equal to or higher than 50° C. and lower than 100° C.

3. The hydrogen generation apparatus according to claim 1, wherein the heating apparatus heats the conveyance belt from an inner side of the conveyance belt.

4. The hydrogen generation apparatus according to claim 1, wherein the heating apparatus heats a region where at least the reaction between the hydrogen carrier and the liquid is started.

5. The hydrogen generation apparatus according to claim 4, wherein the region where the conveyance belt is heated by the heating apparatus at least includes a region where the liquid is ejected from the ejection apparatus onto the surface of the conveyance belt.

6. The hydrogen generation apparatus according to claim 5, wherein the region where the conveyance belt is heated by the heating apparatus includes a region where the hydrogen carrier is applied on the surface of the conveyance belt by the application apparatus.

7. The hydrogen generation apparatus according to claim 1, wherein the heating apparatus includes a belt member configured to abut the conveyance belt, and a heating member configured to heat the belt member.

8. The hydrogen generation apparatus according to claim 7,
wherein the belt member is a film-shaped member, and
wherein the heating apparatus includes a holding member configured to hold the heating member and guide rotation of the belt member.

9. The hydrogen generation apparatus according to claim 7, wherein the heating apparatus includes at least one pair of stretch rollers configured to stretch the belt member, and causes a region of the belt member stretched by the pair of stretch rollers to abut the conveyance belt.

10. The hydrogen generation apparatus according to claim 9, wherein the heating member is disposed between the pair of stretch rollers.

11. The hydrogen generation apparatus according to claim 1, wherein the heating apparatus includes a heating member configured to directly heat the conveyance belt.
